(19) United States
(12) Patent Application Publication
(10) Pub. No.: US 2023/0228286 A1
(43) Pub. Date: Jul. 20, 2023

(54) PROCESS FOR CREATING LOCAL AND CONTROLLED FRANGIBLE AREAS IN COMPOSITES

(71) Applicant: Mission Critical Composites, LLC, Huntington Beach, CA (US)

(72) Inventor: Thomas William Stromgren, Huntington Beach, CA (US)

(21) Appl. No.: 18/095,955

(22) Filed: Jan. 11, 2023

Related U.S. Application Data
(60) Provisional application No. 63/298,574, filed on Jan. 11, 2022.
(60) Provisional application No. 63/298,579, filed on Jan. 11, 2022.

(51) Int. Cl. F16B 5/02; F16B 31/00; B29C 63/00

(52) U.S. Cl. CPC F16B 5/0258; F16B 31/00; B29C 63/0017; B29C 63/0065; B29L 2009/003

(57) ABSTRACT

A method for creating local and controlled frangible areas in composites, comprising: creating an area in a composite component comprised of composite material, the area configured to receive a fastener with a composite thickness that is thinner than a surrounding area of the composite component; replacing the composite material under the area in the composite component with a metal insert; placing Fiberglass plies above and below the insert; and curing the composite component.

This U.S. patent application claims priority under 35 U.S.C. § 119(e) to U.S. Provisional Patent Application No. 63/298,574, filed Jan. 11, 2022, entitled “PROCESSES FOR CREATING LOCAL AND CONTROLLED FRANGIBLE AREAS IN COMPOSITES”, and to U.S. Provisional Patent Application No. 63/298,579, filed Jan. 11, 2022, entitled “PROCESSES FOR CREATING LOCAL AND CONTROLLED FRANGIBLE AREAS IN COMPOSITES”. All of the above are incorporated by reference in their entirety as if set forth in full.

### TECHNICAL FIELD

The embodiments described herein are generally directed to a process for creating local and controlled frangible areas in composites.

### BACKGROUND

Spacecraft and aircraft often have a need to disengage a component or structure either from itself or another structure or fastener when the environment for human intervention is not possible. For example, in FIG. 1A, structure or component 104 may at some point need to be disengaged from a fastener 102. The structure 104 can be made from different materials, usually a metallic, a composite plastic or a hybrid consisting of both materials. Conventional methods used to disengage components or structures, such as component 104, in such environments use a remotely detonated explosive charge located near the component to be removed. Although effective, detonating an explosive charge will create fragments of the component to be removed. These fragments travel at high velocities and can cause great and irreparable damage to nearby fragile and/or sensitive equipment unless precautions are taken to reduce or eliminate the risk of damage.

Depending on the type of composite materials involved, composite materials have very high structural strengths. A common method used, is to create the thinnest cross section (ct) (See FIG. 1A) possible in the area 106 that is to fragment, without compromising the initial strengths originally necessary to keep the component 104 in place before being removed by an explosive charge. Although the area 106 that is to be fractured is usually thin, the composite fibers are continuous and do not fracture easily. This can result in an incomplete disengagement of the component with large pieces still attached causing collateral damage.

FIG. 1B is a close up view of area 106 and illustrates a section 108 of carbon plies under and around area 106.

The intent of the approach illustrated in FIGS. 1A and 1B, is to have the load from an explosive charge (ala) push the component 104 in the direction of shear (Sd) such that the force will shear through all of the continuous composite plies, with a thickness (ct), using the head of the fastener as a fracture path (fp). This can lead to incomplete disengagement of the component 104 because there is no fracture path for the continuous composite plies to follow.

### SUMMARY

In an embodiment, a process for creating local and controlled frangible areas in composites.

According to one aspect, a method for creating local and controlled frangible areas in composites, comprises creating an area in a composite component comprised of composite material, the area configured to receive a fastener with a composite thickness that is thinner than a surrounding area of the composite component; replacing the composite material under the area in the composite component with a metal insert; placing Fiberglass plies above and below the insert; and curing the composite component.

According to another aspect, a composite component comprised of composite material and comprising a local and controlled frangible area that allows the composite component to break away from a fastener comprising a fastener head, comprises a metallic insert in the area below the fastener head; and Fiberglass composite plies above and below the insert that hold the insert in place.

According to another aspect, a method for creating local and controlled frangible areas in composites, comprises creating an area in a composite component comprised of composite material, the area configured to receive a fastener with a composite thickness that is thinner than a surrounding area of the composite component; inserting a gap in the composite material under the area in the composite component; placing Fiberglass plies above and below the composite material under the area in the composite component; and curing the composite component.

According to another aspect, a composite component comprised of composite material and comprising a local and controlled frangible area that allows the composite component to break away from a fastener comprising a fastener head, comprises a gap in the composite material in the area below the fastener head; and Fiberglass composite plies above and below the composite material in the area below the fastener head.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIGS. 1A and 1B illustrate a conventional process for creating local and controlled frangible areas in composites;

FIG. 2 illustrate a local and controlled frangible are created using the process illustrated in FIG. 4;

FIG. 3 illustrates the process of disengagement of the component illustrated in FIG. 2;

FIG. 4 illustrates a process for creating local and controlled frangible areas in composites, according to an example embodiment;

FIG. 5 illustrate a local and controlled frangible are created using the process illustrated in FIG. 7;

FIG. 6 illustrates the process of disengagement of the component illustrated in FIG. 5;

FIG. 7 illustrates a process for creating local and controlled frangible areas in composites, according to another example embodiment;

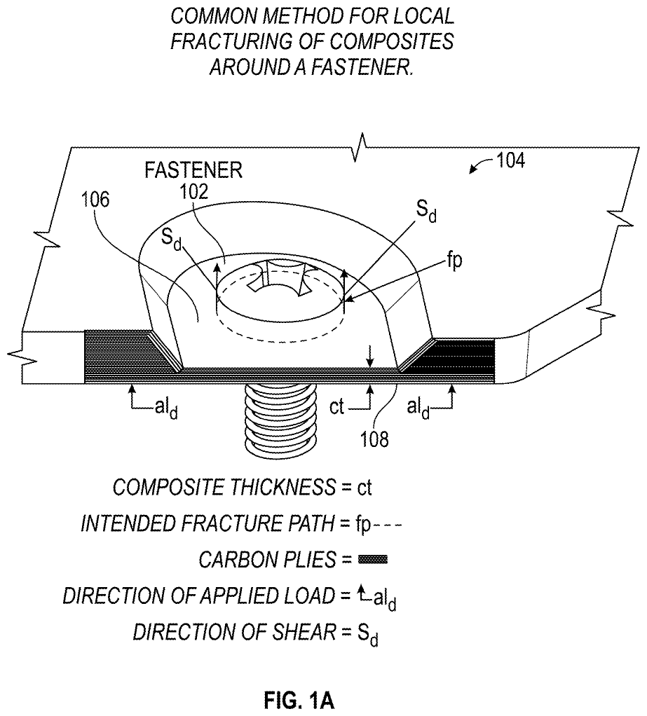

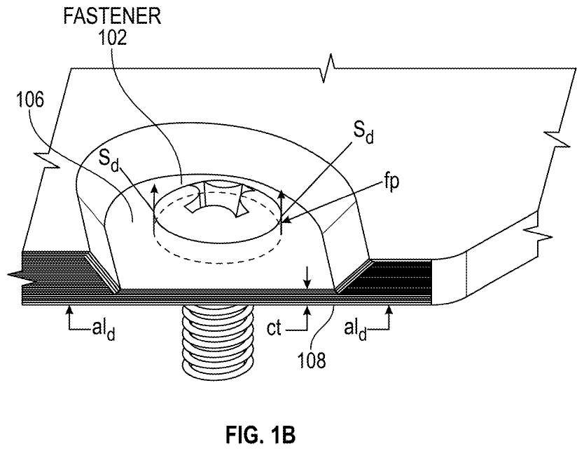

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments; however, it will be apparent to those skilled in the art that embodiments of the invention can be practiced without these specific details. In some instances, well-known structures and components are shown in simplified form for brevity of description.

It should also be understood that the various components illustrated herein are not necessarily drawn to scale. In other words, the features disclosed in various embodiments may be implemented using different relative dimensions within and between components than those illustrated in the drawings.

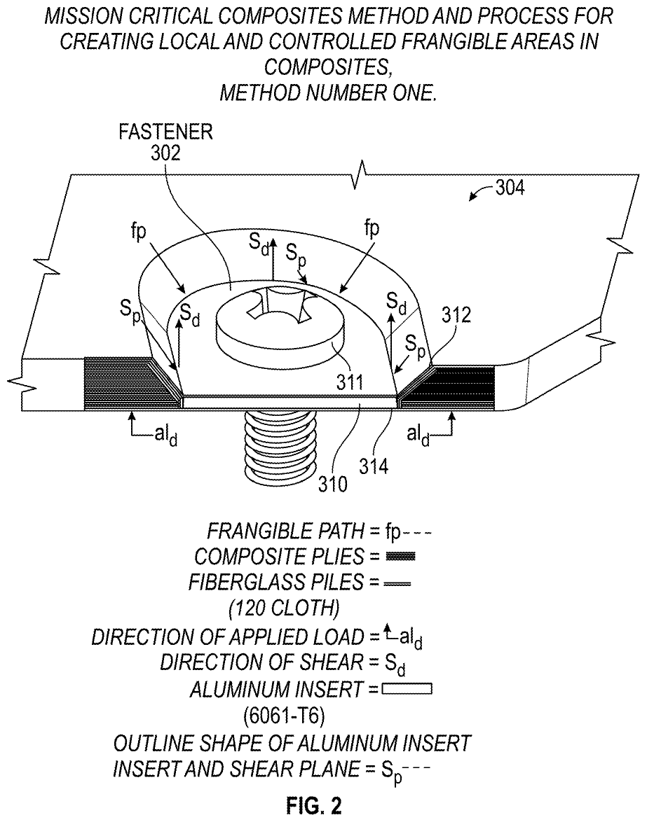

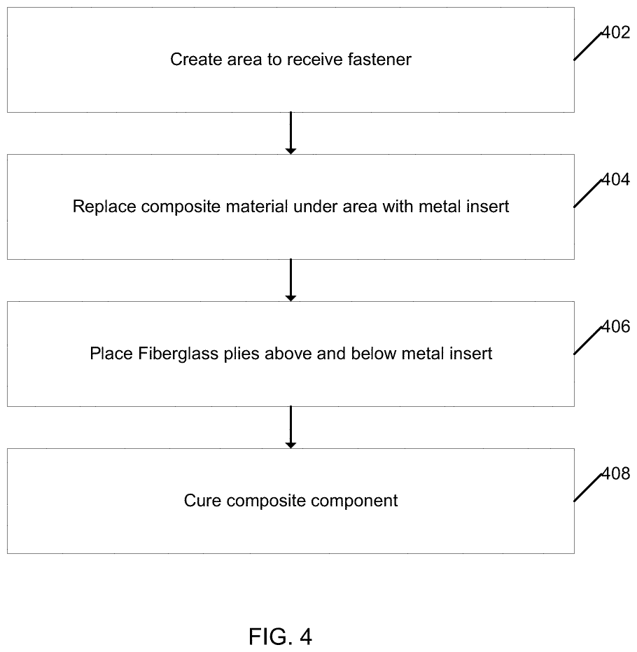

FIG. 2 illustrate a local and controlled frangible area created using the process illustrated in FIG. 4 that allows the component 304 to break away from the fastener 302 in accordance with one embodiment. The continuous plies underneath the fastener head 311 have been removed and replaced with metallic insert 310, Aluminum 6061-T6 is shown as an example. The shape and size of the insert 310 will determine the fracture path (fp) shown in the dashed line. The insert can be of any thickness or shape depending on the application. The insert 310 is held in place by plies 312 of thin, e.g., 120 (3.0 oz.) Fiberglass composite plies above the insert and plies 314 of thin, 120 (3.0 oz.) Fiberglass composite plies below the insert. Each ply can be approximately 0.0046″ thick for a total of 0.0092″ above and below the metallic insert 310. In this case, two Fiberglass plies were used above and below insert 310. When the composite component 304 is cured, the metallic insert 310 is encapsulated within the component 304, secured in place by the Fiberglass plies 312 and 314. The composite component 304 can then be secured to a substructure (not shown) with a fastener 302 as shown in FIG. 2.

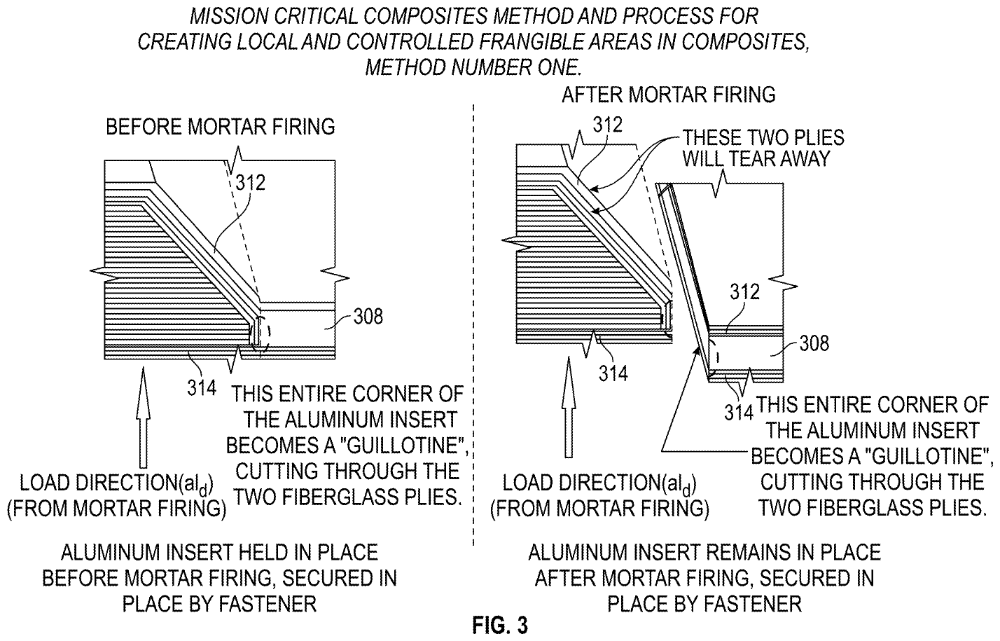

FIG. 3 shows how the composite material fractures along a local and controlled frangible area that produces a fracture path (fp) to allow the component 304 to break away from the fastener 302. When a load is applied (al_{d}) the lower fiberglass plies 314 are cut by the lower edge of the metallic insert 308 held in place by the fastener 302 (like a guillotine) and will be cut along a path that is the shape of the metallic insert 308. The upper fiberglass plies 312 will tear away around the head 311 of the fastener in a similar manner. The fastener 302 and insert 308 remain in place on the substructure (not shown) as the composite component is disengaged.

FIG. 4 is a flow chart illustrating a process for creating a local and controlled frangible area in accordance with one example embodiment. First, in step 402, an area in a composite component and configured to receive a fastener is created with a composite thickness that is thinner than the surrounding area of the composite component. In step 404, the composite material under the area is replace with a metal insert. In step 406, Fiberglass plies are placed above the insert, and in step 408 Fiberglass plies are placed below the insert. In step 410 the composite component is cured.

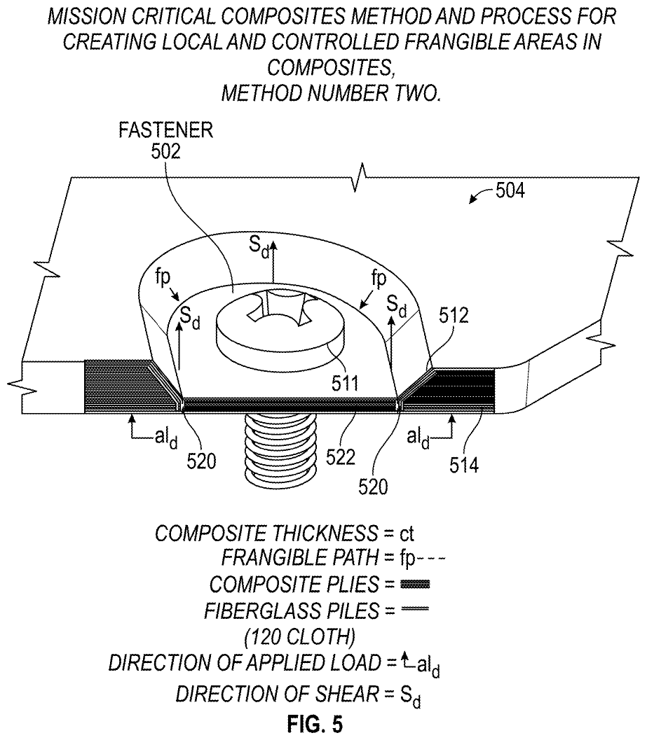

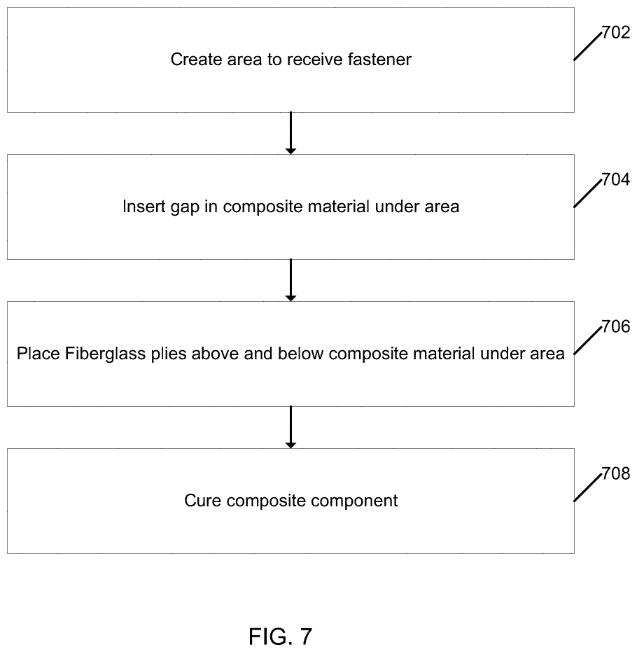

FIG. 5 illustrates a local and controlled frangible are created using the process illustrated in FIG. 7 to allow the composite component to break away from the fastener. Here the continuous plies 522 underneath the fastener head 511 have been interrupted by an intentional gap 520. The shape and size of the gap shown will determine the fracture path (fp) shown in the dashed red line. The gap 520 can be of any thickness or shape depending on the application. The composite section 522 underneath the fastener head is held in place by plies 512 of thin, e.g., 120 (3.0 oz.) Fiberglass composite plies above the insert and plies 514 of thin, 120 (3.0 oz.) Fiberglass composite plies below the insert. Each ply can be approximately 0.0046″ thick for a total of 0.0092″ above and below the section 522. In this case, two Fiberglass plies were used above and below section 522. Resin can be placed in the gap 520. When the composite component 504 is cured, the section 522 is encapsulated within the component 504, secured in place by the Fiberglass plies 512 and 514. The composite component 504 can then be secured to a substructure (not shown) with a fastener 502 as shown in FIG. 5.

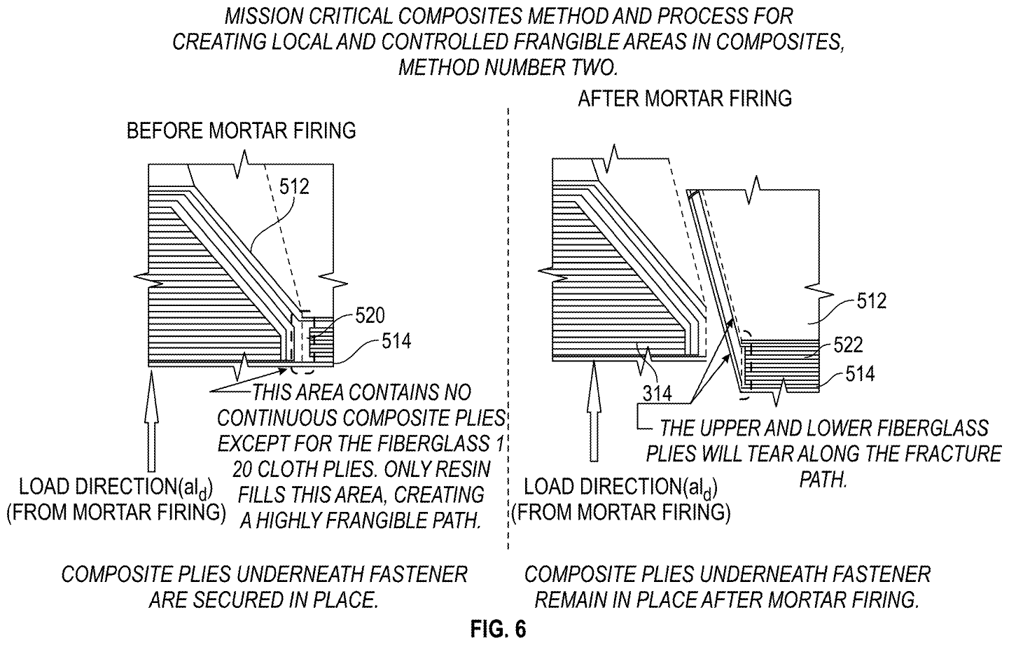

FIG. 6 shows that when a load is applied (aid) the hard, cured resin that fills in the gap 520 will fracture, leaving a sharp edge along the fracture path. The lower fiberglass plies 514 are cut by the lower edge of the composite section 522 held in place by the fastener (like a guillotine). and will be cut along a path that is the shape of the resin filled gap 520. The upper fiberglass plies 512 will tear away around the head 511 of the fastener 502 in a similar manner. The fastener 502 and section 522 remain in place on the substructure (not shown) as the composite component 504 is disengaged.

FIG. 7 is a flow chart illustrating a process for creating a local and controlled frangible area in accordance with one example embodiment. First, in step 702, an area in a composite component and configured to receive a fastener is created with a composite thickness that is thinner than the surrounding area of the composite component. In step 704, A gap is created in a section of the composite material under the area. In step 706, Fiberglass plies are placed above the section of composite material, and in step 408 Fiberglass plies are placed below the composite area. In step 710 the gap is filled with resin. In step 710 the composite component is cured.

The benefits of the process for creating local and controlled frangible areas in composites are as follows: The composite thickness in the frangible area is greatly reduced; with a reduced composite thickness in the frangible area, the amount of applied force necessary for the composite component to breakaway is reduced; the fracture path is known and can be controlled; and the method can be used on composite components having multiple attach points.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of composite material. Hence, although the present embodiments are, for convenience of explanation, depicted and described as being implemented in a particular configuration, it will be appreciated that it can be implemented in various other types of configurations and applications, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A method for creating local and controlled frangible areas in composites, comprising:
creating an area in a composite component comprised of composite material, the area configured to receive a fastener with a composite thickness that is thinner than a surrounding area of the composite component;
replacing the composite material under the area in the composite component with a metal insert;
placing Fiberglass plies above and below the insert; and
curing the composite component.

2. The method of claim 1, wherein the Fiberglass composite plies are thin, 120 (3.0 oz.) Fiberglass composite plies.

3. The method of claim 2, wherein each fiberglass ply can be approximately 0.0046″ thick.

4. A composite component comprised of composite material and comprising a local and controlled frangible area that allows the composite component to break away from a fastener comprising a fastener head, comprising:
a metallic insert in the area below the fastener head; and
Fiberglass composite plies above and below the insert that hold the insert in place.

5. The composite component of claim 4, wherein the Fiberglass composite plies are thin, 120 (3.0 oz.) Fiberglass composite plies.

6. The composite component of claim 5, wherein each fiberglass ply can be approximately 0.0046″ thick.

7. The composite component of claim 4, wherein the insert is made from Aluminum.

8. A method for creating local and controlled frangible areas in composites, comprising:
creating an area in a composite component comprised of composite material, the area configured to receive a fastener with a composite thickness that is thinner than a surrounding area of the composite component;
inserting a gap in the composite material under the area in the composite component;
placing Fiberglass plies above and below the composite material under the area in the composite component; and
curing the composite component.

9. The method of claim 8, further comprising injecting resin into the gap.

10. The method of claim 8, wherein the Fiberglass composite plies are thin, 120 (3.0 oz.) Fiberglass composite plies.

11. The method of claim 8, wherein each fiberglass ply can be approximately 0.0046″ thick.

12. A composite component comprised of composite material and comprising a local and controlled frangible area that allows the composite component to break away from a fastener comprising a fastener head, comprising:
a gap in the composite material in the area below the fastener head; and
Fiberglass composite plies above and below the composite material in the area below the fastener head.

13. The composite component of claim 12, wherein the Fiberglass composite plies are thin, 120 (3.0 oz.) Fiberglass composite plies.

14. The composite component of claim 12, wherein each fiberglass ply can be approximately 0.0046″ thick.

15. The composite component of claim 12, further comprising resin in the gap.
